(19) United States
(12) Patent Application Publication
(10) Pub. No.: US 2005/0216587 A1
(43) Pub. Date: Sep. 29, 2005

(54) Establishing trust in an email client

(75) Inventor: Joseph Won John, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/809,586

(22) Filed: Mar. 25, 2004

(51) Int. Cl. G06F 15/173; G06F 15/16

(52) U.S. Cl. 709/225; 709/206

(57) ABSTRACT

Establishing trust in an email client including accepting in an email server a data communications connection from an email client, where the connection includes the email client's network address; determining from a stored list of trusted network addresses whether the email client is trusted according to the email client's network address; if the email client is not trusted according to the email client's network address, receiving authentication data from the email client and determining whether the email client is trusted according to the authentication data; and if the email client is not trusted according to the email client's network address and the email client is not trusted according to the authentication data, receiving a sender domain name for an email message from the email client and determining whether the email client is trusted according to the sender domain name.

### BACKGROUND OF THE INVENTION

1. Field of the Invention

The field of the invention is data processing, or, more specifically, methods, systems, and products for establishing trust in an email client.

2. Description Of Related Art

When the current email system, particularly the Simple Mail Transfer Protocol (‘SMTP’), was created, no one predicted the phenomenon of unwanted email (‘SPAM’) that is plaguing our’ email systems today. Surveys suggest that a substantial portion, perhaps as much as half, of all email today is SPAM. In wasted time and in expensive attempts to control SPAM and to correct computer damage caused by SPAM, SPAM costs businesses worldwide billions of dollars annually.

One of the problems with the current email systems is that many email exchanges operate as ‘open relays,’ exchanges that accept email with little or no verification of sender identity or authorization to send. The SMTP standard in particular makes client authentication optional—so email exchanges are permitted to operate within the SMTP network generally without verifying a sender's identity in any way. Senders of SPAM use such open relays by simply forging the sender's identity in SMTP MAILFROM messages. This makes it very difficult to trace the origin of SPAM messages so forged and therefore very difficult to control the generation of more and more SPAM.

Several methods have been tried to prevent or block SPAM. Some email clients and email exchanges implement blacklists, lists of IP addresses of known senders of SPAM and open relays used by senders of SPAM. Some email clients and exchanges implement whitelists, exclusive listings of network addresses from which an exchange or client will accept email. Blacklists and whitelists, however, are low performance solutions because they require a high degree of maintenance. Some email clients and exchanges implement mail filtering according to rules, excluding email containing certain keywords, for example. Mail filtering, however, can have a high performance cots because each email message must be scanned and because it is fairly easy for SPAM senders to avoid filters by making small c*h*a*n*g*e*s to the content of the messages. For all these reasons, there is an ongoing need for improvement in email systems.

### SUMMARY OF THE INVENTION

Methods, systems, and products are disclosed for establishing trust in an email client that include accepting in an email server a data communications connection from an email client, where the connection includes the email client's network address. In some embodiments of the present invention, the email client is an email exchange that accepts outbound email messages only from trusted senders. Typical embodiments include determining from a stored list of trusted network addresses whether the email client is trusted according to the email client's network address. If the email client is not trusted according to the email client's network address, typical embodiment include receiving authentication data from the email client and determining whether the email client is trusted according to the authentication data.

If the email client is not trusted according to the email client's network address and the email client is not trusted according to the authentication data, typical embodiment include receiving a sender domain name for an email message from the email client and determining whether the email client is trusted according to the sender domain name. In some embodiments, receiving a sender domain name includes receiving the sender domain name in an SMTP MAILFROM message. If the email client is not trusted according to the email client's network address, the email client is not trusted according to the authentication, and the email client is not trusted according to the sender domain name, typical embodiments include sending an error message to the email client and closing the connection.

In typical embodiments, determining whether the email client is trusted according to the sender domain name also includes requesting from a domain name service a resource record of a type that lists network addresses of email exchanges that are authorized to act as outbound email exchanges for the sender domain. In typical embodiments, determining whether the email client is trusted according to the sender domain name also includes determining whether a domain name service resource record associates the email client's network address with the sender domain name, the DNS resource record being of a type that lists for a sender domain network addresses of email exchanges that are authorized to act as outbound email exchanges for the sender domain. In embodiments where the email client is trusted according to the authentication data, the method typically also includes storing the email client's network address in association with a trust time limit in the list of trusted network addresses.

Typical embodiments also include accepting in the email server a connection from an email client requesting delivery of an email message according to a protocol that includes client authentication, wherein the connection includes the network address of the email client requesting delivery of an email message; authenticating the email client requesting delivery of an email message; delivering the email message to the email client requesting delivery of an email message; and storing the network address of the email client requesting delivery of an email message in association with a trust time limit in the list of trusted network addresses.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an exemplary data processing system capable of establishing trust in an email client according to embodiments of the present invention.

FIG. 2 sets forth a block diagram of exemplary automated computing machinery comprising a computer useful in establishing trust in an email client according to embodiments of the present invention.

FIG. 3 sets forth a flow chart illustrating an exemplary method for establishing trust in an email client.

FIG. 4 sets forth a flow chart illustrating an exemplary method of determining whether an email client is trusted according to a sender domain name.

FIG. 5 sets forth a flow chart illustrating an exemplary method for establishing trust in an email client that is an extension of the method of FIG. 3.

### DETAILED DESCRIPTION OF EXEMPLARY EMBODIMENTS

### Introduction

The present invention is described to a large extent in this specification in terms of methods for establishing trust in an email client. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette, tape, or other recording medium, for use with any suitable data processing system. Embodiments of a computer program product may be implemented by use of any recording medium for machine-readable information, including magnetic media, optical media, transmission media, or other suitable media. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

### Establishing Trust in an Email Client

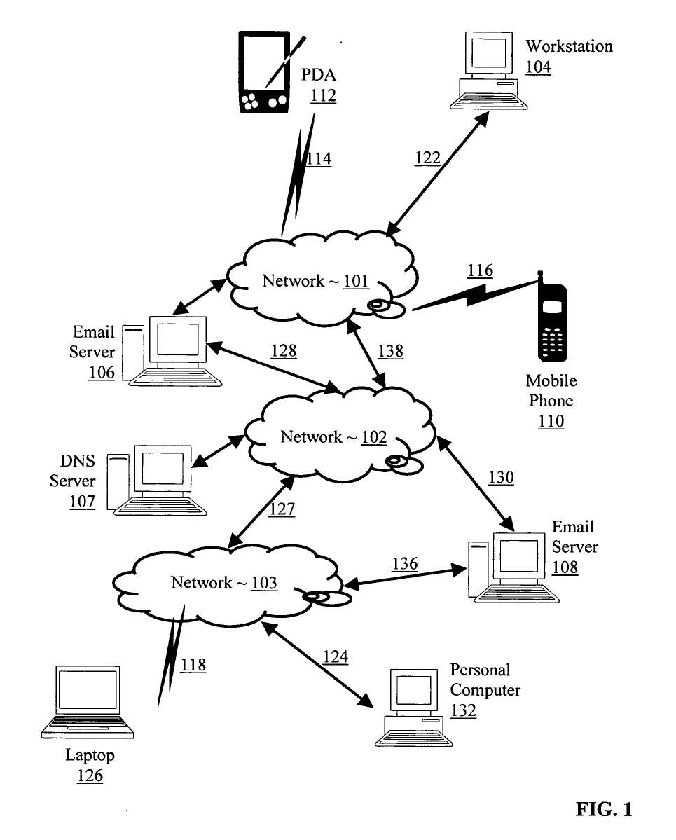

Exemplary methods, systems, and products for establishing trust in an email client are now explained with reference to the accompanying drawings, beginning with FIG. 1. FIG. 1 depicts an exemplary data processing system capable of establishing trust in an email client according to embodiments of the present invention. The system of FIG. 1 includes a number of computing devices connected for data communications through networks. Each of the devices in the system of FIG. 1 may function as an email client, and at least two of the devices (106, 108) are configured also to act as email servers. The data processing system of FIG. 1 includes three networks ( 101, 102, 103), each of which supports email and each of which may be a local area network (‘LAN’), a wide area network (‘WAN’), an intranet, internet, or any other kind of network as will occur to those of skill in the art that supports email. In the example of FIG. 1, networks (101, 102, 103) are connected (127, 138) to function as a wide area network supporting email.

The network connection aspect of the architecture of FIG. I is only for explanation, not for limitation. In fact, systems for establishing trust in an email client according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

As mentioned above, each of the devices in the system of FIG. 1 may function as an email client. The devices that may function as email clients as shown in FIG. 1 include: Personal digital assistant (‘PDA’) (112), which connects to network (101) through wireless link (114); computer workstation (104), which connects to network (101) through wireline link (122), network-enabled mobile phone (110), which connects to network (101) through wireless link (116), personal computer (132) which connects to network (103) through wireline link (124), and laptop computer (126) which connects to network (103) through wireless link (118).

The devices that may function as email clients as shown in FIG. I also include email server (106) and email server (108). Each email server may accept email messages for relay through another email server. When an email server connects to another email server to relay email messages, the first server is functioning as an email client. That is, whether an email host is considered an email client or an email server is defined by its current function. Any device capable of sending and receiving email may function as a email client. Any device capable of accepting email messages for further delivery to another device may function as an email server.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, SMTP, POP, IMAP, and others as will occur to those of skill in the art. Various embodiments of the present invention may be implemented on a variety of hardware platforms in addition to those illustrated in FIG. 1.

Each server in FIG. 1 is configured to establish trust in an email client by accepting a data communications connection from an email client, where the connection includes the email client's network address. Each server may determine from a stored list of trusted network addresses whether the email client is trusted according to the email client's network address. If the email client is trusted according to the email client's network address, email processing in the server continues normally. If the email client is not trusted according to the email client's network address, the server receives authentication data from the email client, and determines whether the email client is trusted according to the authentication data. If the email client is trusted according to the authentication data, email processing continues normally. If the email client is not trusted according to the email client's network address and the email client is not trusted according to the authentication data, the server then receives a sender domain name for an email message from the email client and determines whether the email client is trusted according to the sender domain name. If the email client is trusted according to the sender domain name, email processing continues normally. If the email client is not trusted according to the sender domain name, the server sends an error message to the email client and terminates email processing by closing the data communications connection between the client and the server.

The following is a pseudocode example of an exemplary server process that opens a socket on a port and accepts a data communications connection from an email client, where the connection includes the email client's network address:

```
int listenSocket, connectSocket;
int QUEUE_SIZE = 5;
if ((listenSocket = socket( ... )) < 0 )
    err_sys(“socket error”);
if(bind(listenSocket, ... ) < 0 )
    err_sys(“bind error”);
if(listen(listenSocket, ... ) < 0 )
    err_sys(“listen error”);
for(;;) {
    connectSocket = accept(connectSocket, ...);
    if(connectSocket < 0)
        err_sys(“accept error”);
    if(fork( ) == 0) {
        /*** child process ***/
        close(listenSocket);
        if(t = trustPerAddress(connectSocket)) == TRUE )
            processEmailNormally(connectSocket);
        else if(t = trustPerAuthenticationData(connectSocket)) == TRUE
            processEmailNormally(connectSocket);
        else if (t = trustPerSenderDomainName(connectSocket)) ==
        TRUE)
            processEmailNormally(connectSocket);
        else {
            sendErrorMsgToClient(connectSocket);
            close(connectSocket);
        }
            exit(0);
        }
        close(connectSocket);
    }
```

When a connection request is received and accepted, the server process forks, with the child process servicing the connection and the parent process waiting for another connection request. The connectSocket descriptor returned by accept( ) refers to a complete TCP association, a ‘connection,’ a data structure housing the complete network addresses and port numbers for both client and server for this connection. On the other hand, the listenSocket argument that is passed to accept( ) only has the network address and the port number for the server process. The client network address and client port number are unknown at that point and remain so until accept( ) returns. This allows the original process, the parent, to accept( ) another connection using listenSocket without having to create another socket descriptor. This server, like most connection-oriented servers, is a concurrent processor, and so creates a new socket (‘connectSocket’) automatically as part of the accept( ) system call. In this way, the system continues to use the same socket for all listening on the port (‘listenSocket’), while using a new socket (‘connectSocket’) for each new connection for server processing.

“TCP” stands for ‘Transmission Control Protocol,’ the standard connection-oriented, transport-layer, data communications protocol on the Internet. “Internet” refers to the world wide network of devices that operate the “Internet Protocol (“IP”) in the network layers of their data communications protocol stacks. TCP and IP are used together so frequently that they are often referred to as the “TCP/IP protocol suite—or simply as “TCP/IP.” The use of TCP/IP is not a requirement of the present invention. In fact, systems may establish trust in an email client according to embodiments of the present invention through the use of any connection-oriented data communications protocol as will occur to those of skill in the art. TCP/IP is so common in usage, however, that it makes a good example for explanation and is therefore often used for that purpose in this specification. Similarly, the email protocols SMTP (‘Simple Mail Transfer System’), POP (‘Post Office Protocol’), and IMAP (‘Internet Message Access Protocol’) also are used as examples in this specification, although they are not limitations of the present invention, and systems may establish trust in an email client according to embodiments of the present invention through the use of any email protocol as will occur to those of skill in the art.

In the server processing illustrated in the pseudocode example above, the function named trustPerAddress(connectSocket) can determine from a stored list of trusted network addresses whether the email client is trusted according to the email client's network address. The email client's network address is available in connectSocket, and search a table like Table 1 to determine whether the email client's network address is listed in the server as a trusted address.

TABLE 1
Trusted Network Addresses

| Email Client | |
|---|---|
| Network Address | Trust Time Limit |
| 207.171.182.16 | |
| 66.135.192.87 | |
| 192.168.1.0-192.168.255.255 | |
| 129.42.19.99 | Oct. 31, 2004 - 05:00 |
| 66.219.49.183 | Nov. 30, 2004 - 23:59 |

Each record in Table 1 represents an email client network address trusted by the system having the table. The records may be created manually, through a text editor, by a system administrator, or they may be created automatically in some circumstances according to embodiments of the present invention. The records for email client network addresses 207.171.182.16 and 66.135.192.87 have no trust time limit and are therefore considered email client network addresses for email clients always to be trusted.

The third record in Table 1 lists a range of trusted network addresses, 192.168.1.0-192.168.255.255. A range of trusted network addresses is useful when, for example, an email server provides outbound email service for email clients on a LAN where the clients' network addresses are temporary and variable but always fall within a known range, as they would be for IP addresses assigned by a local DHCP service, for example. In the example of Table 1, the record bearing the range of trusted network addresses has an empty trust time limit field, indicating that clients with network addresses in the address range are always to be trusted.

The records for email client network addresses 129.42.19.99 and 66.219.49.183 have trust time limits, Oct. 31, 2004, at 5:00 a.m. and Nov. 30, 2004, at just about midnight, respectively, so that an email client connecting to the server from either of these two addresses are to be trusted only temporarily, prior to expiration of their respective trust time limits. A system according to an embodiment of the present invention may have relatively few trusted addresses for storage in a table like Table 1. Data from such a table therefore advantageously may be kept in RAM in the form of a list or hash table for very quick access. Temporary trust, when it can be established, therefore is useful because establishing trust by use of a lookup against a short list in RAM may be faster than other ways of establishing trust.

An email client may establish temporary trust by first establishing trust in another way, such as, for example, by authentication. An email client may authenticate with a server through an authenticating SMTP connection, through a POP connection, or through an IMAP connection, for example. Client authentication is not always required for SMTP connections, but it is generally required for POP and IMAP. A client may connect to a server from a wireless hotspot in a coffee shop or airport where the client's network address is a temporary one assigned, for example, by a DHCP (‘Dynamic Host Configuration Protocol’) server. Such a client may attempt to send or receive email from a server several times while the client is connected from a temporary network address. It may be more efficient to authenticate the client on its first connection to the system, store its network address with a trust time limit in a table like Table 1, and then establish trust for the client during subsequent connections, subject to the trust time limit, with a lookup in the table instead of an authentication process, the lookup being faster.

As mentioned, if the email client is trusted according to the email client's network address, email processing in the server continues normally, represented in the pseudocode example by the call to processEmailNormally(connectSocket). If the email client is not trusted according to the email client's network address, the server receives authentication data from the email client, and determines whether the email client is trusted according to the authentication data. In the pseudocode example, the function trustPerAuthenticationData(connectSocket) can receive authentication data from the email client in, for example, an SMTP authentication exchange. A server that uses SMTP authentication may support many authentication mechanisms, including, for example, the following:, such as, for example, the following:
Anonymous (RFC 2245)
CRAM-MD5 (RFC 2195)
Digest-MD5 (RFC 2831)
External (RFC 2222)
Kerberos V4 (RFC 2222)
Kerberos V5 (RFC 2222)
SecurID (RFC 2808)
Secure Remote Password (draft-burdis-cat-srp-sasl-06.txt)
S/Key (RFC 2222)
X.509 (draft-ietf-ldapext-x509-sasl-03.txt)

In the following example SMTP message exchange, the server represents that it supports two authentication mechanisms, CRAM-MD5 DIGEST-MD5, and the client and server agree to use the authentication mechanism called CRAM-MD5 for ‘Challenge/Response Authentication Mechanism’ with MD5 encryption:

| | |
|---|---|
| Server: | 220 smtp.example.com ESMTP server ready |
| Client: | EHLO jgm.example.com |
| Server: | 250-smtp.example.com |
| Server: | 250 AUTH CRAM-MD5 DIGEST-MD5 |
| Client: | AUTH CRAM-MD5 |
| Server: | /*** sends challenge authentication data ***/ |
| Client: | /*** sends response authentication data ***/ |
| Server: | 235 Authentication successful. |

If the email client is trusted according to the authentication data, email processing continues normally. If the email client is not trusted according to the email client's network address and the email client is not trusted according to the authentication data, the server then can receive a sender domain name for an email message from the email client and determine whether the email client is trusted according to the sender domain name. Receiving a sender domain name for an email message from the email client and determining whether the email client is trusted according to the sender domain name is represented in the pseudocode example above by the function call:
trustPerSenderDomainName(connectSocket).

TrustPerSenderDomainName(connectSocket) functions in this example by receiving a sender domain name for an email message from the email client in, for example, an SMTP ‘MAILFROM’ message, and then requesting a DNS (‘Domain Name Server’) resource record from DNS server (107) for the sender domain name. In this example, the sender domain name is represented to be the domain name of the email client that originated the message, although the sender domain name may be a forgery. The resource record requested is of a new type, according to embodiments of the present invention, that lists for a sender domain network addresses of email exchanges that are authorized to act as outbound email exchanges for the sender domain. In this specification, DNS resource records that list network addresses of email exchanges that are authorized to act as outbound email exchanges for a sender domain are referred to as ‘OX records’ for ‘Outbound exchange.’

Domain Name Services, as defined in RFC 1035 and many other IETF RFCs, use ‘resource records’ to store the attributes of domain names. Each domain name may have many attributes stored in resource records associated with the domain name. DNS service use a request-response communications protocol to provide resource records to DNS clients. Many resource record types are defined in the pertinent RFCs, including resource records, for example, that describe a host address for a domain name, canonical names for aliases, host CPUs and operating systems, and domain names of hosts willing to act as mail exchanges for a domain. ‘MX,’ standing for ‘Mail Exchange,’ is the type code for the resource records that identify hosts willing to act as mail exchanges for a domain. That is, MX records identify hosts that accept email for delivery to a domain. OX records, in contrast, identify hosts that are authorized to send email on behalf of a domain.

In this example, trustPerSenderDomainName(connectSocket) determines whether the email client is trusted according to the sender domain name by retrieving an OX record for the sender domain name and examining the OX record to determine whether it associates the email client's network address with the sender domain name. If the OX record for the sender domain name contains the email client's network address, that is a representation that the email client is an email exchange authorized to send outbound email on behalf of the sender's domain. Remember that in this kind of example, the email client itself is in fact probably an email server functioning either as an intervening relay or as a principal outbound server for the sender domain, so that the email client and the sender may be two different devices. If the email client is trusted according to the sender domain name, email processing continues normally. If the email client is not trusted according to the sender domain name, the server sends an error message to the email client and terminates email processing by closing the data communications connection between the client and the server, represented by the following lines in the pseudocode for the exemplary server process set forth above:
sendErrorMsgToClient(connectSocket);
close(connectSocket);

As mentioned above, establishing trust in an email client in accordance with the present invention is generally implemented with computers, that is, with devices implementing automated computing machinery. Examples of automated computing machinery include personal computers, minicomputers, mainframe computers, laptops, PDAs, network-enabled mobile telephones, other wireless handheld devices, and so on, as will occur to those of skill in the art.

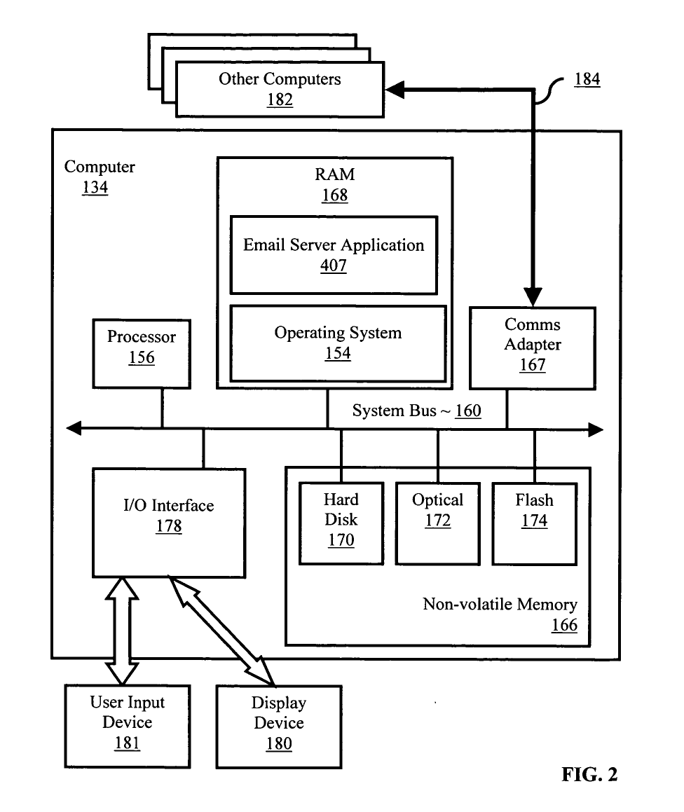

For further explanation, FIG. 2 sets forth a block diagram of exemplary automated computing machinery comprising a computer (134) useful in establishing trust in an email client according to embodiments of the present invention. The computer (134) of FIG. 2 includes at least one computer processor (156) or ‘CPU’ as well as random access memory (168) (“RAM”). Stored in RAM (168) is an email server application (407) such as the executable portion of an SMTP server, a POP server, or an IMAP server. Also stored in RAM (168) is an operating system (154). Operating systems useful in computers according to embodiments of the present invention include Unix, Linux, Microsoft NT™, and many others that will occur to those of skill in the art. Operating system (154) in the example of FIG. 2 is shown in RAM (154), but many components of an operating system typically are stored in non-volatile memory (166) also.

The computer (134) of FIG. 2 includes non-volatile computer memory (166) coupled through a system bus (160) to processor (156) and to other components of the computer storing a plurality of available browsers (405). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (134) of FIG. 2 includes a communications adapter (167) for implementing connections for data communications (184), including connections through networks, to other computers (182), including email servers, email clients, and others as will occur to those of skill in the art. Communications adapters implement the hardware level of connections for data communications through which local devices and remote devices or servers send data communications directly to one another and through networks. Examples of communications adapters useful for establishing trust in an email client according to embodiments of the present invention include modems for wired dial-up connections, Ethernet (IEEE 802.3) adapters for wired network connections, and 802.11b adapters for wireless network connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

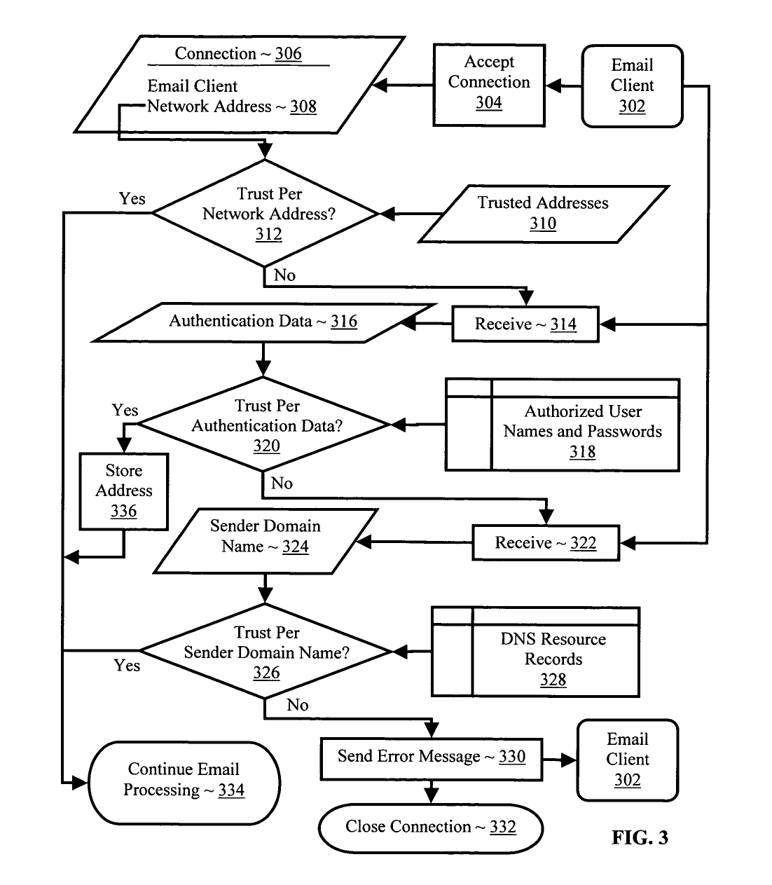

For further explanation, FIG. 3 sets forth a flow chart illustrating an exemplary method for establishing trust in an email client that includes accepting (304) in an email server a data communications connection (306) from an email client (302). Accepting (304) a data communications connection (306) can be carried out through a sequence of socket API calls effecting a TCP connection as illustrated in more detail in the exemplary pseudocode server process set forth above. In this example, the connection (306) includes the email client's network address (308), as does the connectSocket structure in the pseudocode process described above.

In the method of FIG. 3, when email client (302) is an email exchange acting as a relay rather than a email client that originates an email message, then email client (302) advantageously is an email exchange that accepts outbound email messages only from trusted senders. Building an email system in which servers accept (304) data communications connections only from email clients that accept outbound email messages only from trusted senders advantageously reduces the risk of email forgery and unwanted email because there are no open relays in such a system.

The method of FIG. 3 includes determining (312) from a stored list of trusted network addresses (310) whether the email client (302) is trusted according to the email client's network address. The stored list of trusted network addresses (310) may be implemented as described above for Table 1, where each record in the table represents trust for an email client connecting from an address listed in the table, and determining whether determining (312) from a stored list of trusted network addresses (310) whether the email client (302) is trusted according to the email client's network address is carried out by searching for a record containing the email client's network address (308). In the method of FIG. 3, if a record is found that contains the email client's network address (308), trust is established, and email processing continues normally (334).

If the email client is not trusted according to the email client's network address, the method of FIG. 3 proceeds by receiving (314) authentication data (316) from the email client and determining (320) whether the email client is trusted according to the authentication data. Receiving (314) authentication data (316) from the email client and determining (320) whether the email client is trusted according to the authentication data may be carried out by SMTP authentication, for example, as described above. In the method of FIG. 3, if the client authenticates, trust is established, and email processing continues normally (334). In addition, in the example of FIG. 3, if the email client is trusted according to the authentication data, the illustrated method includes storing (336) the email client's network address in association with a trust time limit in the list (310) of trusted network addresses. Storing (336) the email client's network address in association with a trust time limit in the list (310) of trusted network addresses may be carried out by use of a data structure like that shown above in Table 1. Storing (336) the email client's network address in association with a trust time limit in the list (310) of trusted network addresses advantageously improves the efficiency of the process of establishing trust for an email client for email clients using temporary IP addresses.

If the email client is not trusted according to the email client's network address and the email client is not trusted according to the authentication data, the method of FIG. 3 includes receiving (322) a sender domain name (324) for an email message from the email client and determining (326) whether the email client is trusted according to the sender domain name. The sender domain name (324) may be taken from the sender's email address in an SMTP MAILFROM message, and determining (326) whether the email client is trusted according to the sender domain name may be carried out by retrieving from a store (328) of DNS resource records an OX record for the sender domain and examining the OX record for the email client's network address. In the method of FIG. 3, if the email client's network address is found in the OX record, trust is established, and email processing continues normally (334).

In the method of FIG. 3, when the email client (302) is not trusted according to the email client's network address, the email client is not trusted according to the authentication, and the email client is not trusted according to the sender domain name, then the method of FIG. 3 includes sending (330) an error message to the email client and closing (332) the data communications connection (306), represented by the following lines in the pseudocode for the exemplary server process set forth above:
sendErrorMsgToClient(connectSocket);
close(connectSocket);

The error message itself may be implemented, for example, as an SMTP message:
554 Transaction Failed—Untrusted Email Client.

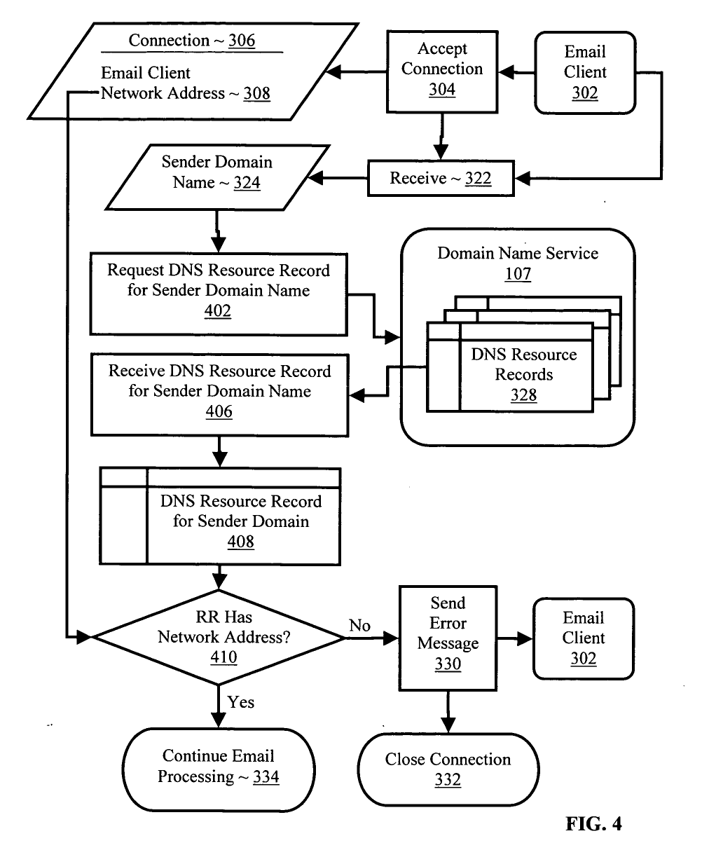

For further explanation, FIG. 4 sets forth a flow chart illustrating an exemplary method of determining whether an email client is trusted according to a sender domain name that includes requesting (402) from a domain name service (107) a resource record of a type that lists for a sender domain network addresses of email exchanges that are authorized to act as outbound email exchanges for the sender domain. In this specification, such a resource record is called an ‘OX record.’ The method of FIG. 4 includes receiving (406) the OX record for the sender domain from the domain name service (107). The method of FIG. 4 also includes determining (410) whether the DNS resource record (408), the OX record, associates the email client's network address with the sender domain name. If it does, email processing continues normally (334). If the OX record (408) for the sender domain does not contain the email client's network address, trust is not established for the email client, and the method proceeds by sending (330) an error message to the email client (302) and closing (332) the data communications connection (306) between the server and the email client (302).

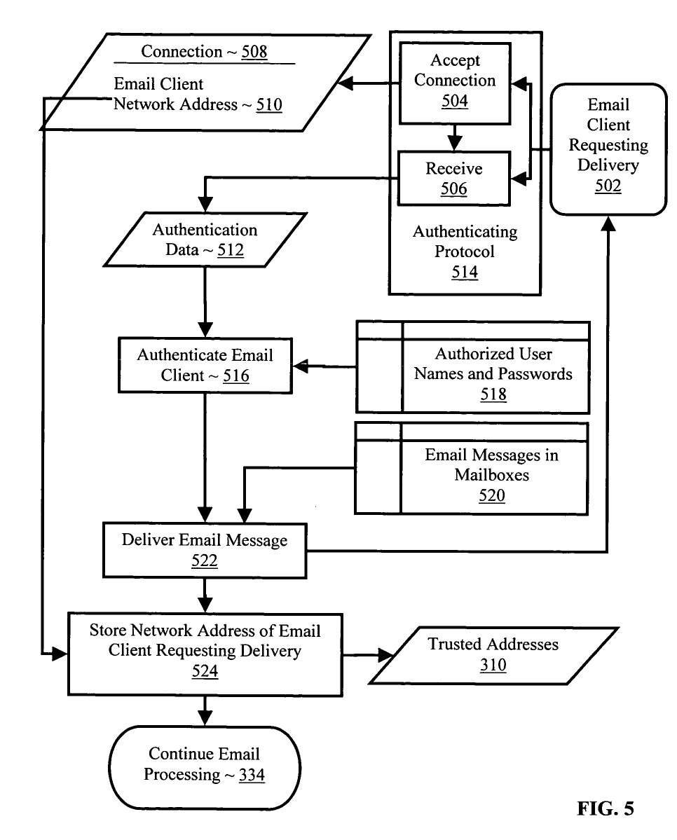

For further explanation, FIG. 5 sets forth a flow chart illustrating an exemplary method for establishing trust in an email client that is an extension of the method described above in connection with FIG. 3. The method of FIG. 5 includes accepting (504) in the email server a connection (508) from an email client (502) requesting delivery of an email message according to a protocol (514) that includes client authentication, where the connection (508) includes the network address (510) of the email client requesting delivery of an email message. Examples of email protocols that include client authentication include POP, IMAP, and optionally SMTP. An example of a data communications connection (508) that includes the network address (510) of the email client requesting delivery of an email message is the TCP socket structure named ‘connectSocket’ in the pseudocode server process described above.

The method of FIG. 5 includes authenticating (516) the email client requesting delivery of an email message, which can be carried out through any of the authentication mechanisms described above, CRAM-MD5, Digest-MD5, Kerberos, S/Key, X.509, and so on. The method of FIG. 5 also includes delivering (522) the email message to the email client (502) requesting delivery of an email message and storing (524) the network address (510) of the email client requesting delivery of an email message in association with a trust time limit in the list (310) of trusted network addresses. Through this description, readers will understand that the method of FIG. 5 establishes for the email client (502) requesting delivery of an email message a temporary trust record in a list such as that shown above in Table 1. The email client (502) requesting delivery of an email message may not be sending a message when it connects according to the method of FIG. 5, but it may be connecting from a temporary IP address issued to it through DHCP because the email client in question may be accessing its IMAP email from an 802.11b wireless link in a coffee shop or airport. If such an IMAP server is modified according to embodiments of the present invention to grant temporary trust for an hour to such an email client, then, if that email client connects several more times during that hour to check its email, those subsequent connection may be trusted more efficiently according to the email client's network address without the need for full authentication every time that email client connects to that server server.

From this description, readers will understand that implementing email service according to embodiments of the present invention has the benefit of permitting email exchanges to provide relay services for email client whose are not listed as trusted and who do not authenticate with a relaying server so long as the email client offers email for relay from a sender whose domain name has a DNS OX record listing the email client's network address. Implementation of methods, systems, and products according to embodiments of the present invention can substantially eliminate the kind of ‘open relay’ that is so susceptible to sender identity forgery and SPAM while still permitting relay functionality through servers that check OX records. In fact, except for the addition of OX records as a type of DNS resource record, an expansion of DNS that DNS was specifically designed to accommodate, implementing email service according to embodiments of the present invention has no effect at all on current standards of email processing. Command structure, handshake methods, and message types in SMTP, IMAP, and POP, for example, are all unaffected by implementation of methods, systems, and products according to embodiments of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for establishing trust in an email client, the method comprising:
accepting in an email server a data communications connection from an email client, wherein the connection includes the email client's network address;
determining from a stored list of trusted network addresses whether the email client is trusted according to the email client's network address;
if the email client is not trusted according to the email client's network address, receiving authentication data from the email client and determining whether the email client is trusted according to the authentication data; and
if the email client is not trusted according to the email client's network address and the email client is not trusted according to the authentication data, receiving a sender domain name for an email message from the email client and determining whether the email client is trusted according to the sender domain name.

2. The method of claim 1 wherein determining whether the email client is trusted according to the sender domain name further comprises requesting from a domain name service a resource record of a type that lists for a sender domain network addresses of email exchanges that are authorized to act as outbound email exchanges for the sender domain.

3. The method of claim 1 wherein determining whether the email client is trusted according to the sender domain name further comprises determining whether a domain name service resource record associates the email client's network address with the sender domain name, the DNS resource record being of a type that lists for a sender domain network addresses of email exchanges that are authorized to act as outbound email exchanges for the sender domain.

4. The method of claim 1 wherein the email client is trusted according to the authentication data, and the method further comprises storing the email client's network address in association with a trust time limit in the list of trusted network addresses.

5. The method of claim 1 further comprising:
accepting in the email server a connection from an email client requesting delivery of an email message according to a protocol that includes client authentication, wherein the connection includes the network address of the email client requesting delivery of an email message;
authenticating the email client requesting delivery of an email message;
delivering the email message to the email client requesting delivery of an email message; and
storing the network address of the email client requesting delivery of an email message in association with a trust time limit in the list of trusted network addresses.

6. The method of claim 1 wherein the email client is an email exchange that accepts outbound email messages only from trusted senders.

7. The method of claim 1 wherein receiving a sender domain name further comprises receiving the sender domain name in an SMTP MAILFROM message.

8. The method of claim 1 wherein the email client is not trusted according to the email client's network address, the email client is not trusted according to the authentication, the email client is not trusted according to the sender domain name, and the method further comprises sending an error message to the email client and closing the connection.

9. A system for establishing trust in an email client, the system comprising:
means for accepting in an email server a data communications connection from an email client, wherein the connection includes the email client's network address;
means for determining from a stored list of trusted network addresses whether the email client is trusted according to the email client's network address;
means for receiving authentication data from the email client and means for determining whether the email client is trusted according to the authentication data if the email client is not trusted according to the email client's network address; and
means for receiving a sender domain name for an email message from the email client and means for determining whether the email client is trusted according to the sender domain name if the email client is not trusted according to the email client's network address and the email client is not trusted according to the authentication data.

10. The system of claim 9 wherein means for determining whether the email client is trusted according to the sender domain name further comprises means for requesting from a domain name service a resource record of a type that lists for a sender domain network addresses of email exchanges that are authorized to act as outbound email exchanges for the sender domain.

11. The system of claim 9 wherein means for determining whether the email client is trusted according to the sender domain name further comprises means for determining whether a domain name service resource record associates the email client's network address with the sender domain name, the DNS resource record being of a type that lists for a sender domain network addresses of email exchanges that are authorized to act as outbound email exchanges for the sender domain.

12. The system of claim 9 wherein the email client is trusted according to the authentication data, and the system further comprises means for storing the email client's network address in association with a trust time limit in the list of trusted network addresses.

13. The system of claim 9 further comprising:
means for accepting in the email server a connection from an email client requesting delivery of an email message according to a protocol that includes client authentication, wherein the connection includes the network address of the email client requesting delivery of an email message;
means for authenticating the email client requesting delivery of an email message;
means for delivering the email message to the email client requesting delivery of an email message; and
means for storing the network address of the email client requesting delivery of an email message in association with a trust time limit in the list of trusted network addresses.

14. The system of claim 9 wherein the email client is an email exchange that accepts outbound email messages only from trusted senders.

15. The system of claim 9 wherein means for receiving a sender domain name further comprises means for receiving the sender domain name in an SMTP MAILFROM message.

16. The system of claim 9 further comprising means for sending an error message to the email client and means for closing the connection if the email client is not trusted according to the email client's network address, the email client is not trusted according to the authentication, and the email client is not trusted according to the sender domain name.

17. A computer program product for establishing trust in an email client, the computer program product comprising:
means, recorded on the recording medium, for accepting in an email server a data communications connection from an email client, wherein the connection includes the email client's network address;
means, recorded on the recording medium, for determining from a stored list of trusted network addresses whether the email client is trusted according to the email client's network address;
means, recorded on the recording medium, for receiving authentication data from the email client and means, recorded on the recording medium, for determining whether the email client is trusted according to the authentication data if the email client is not trusted according to the email client's network address; and
means, recorded on the recording medium, for receiving a sender domain name for an email message from the email client and means, recorded on the recording medium, for determining whether the email client is trusted according to the sender domain name if the email client is not trusted according to the email client's network address and the email client is not trusted according to the authentication data.

18. The computer program product of claim 17 wherein means, recorded on the recording medium, for determining whether the email client is trusted according to the sender domain name further comprises means, recorded on the recording medium, for requesting from a domain name service a resource record of a type that lists for a sender domain network addresses of email exchanges that are authorized to act as outbound email exchanges for the sender domain.

19. The computer program product of claim 17 wherein means, recorded on the recording medium, for determining whether the email client is trusted according to the sender domain name further comprises means, recorded on the recording medium, for determining whether a domain name service resource record associates the email client's network address with the sender domain name, the DNS resource record being of a type that lists for a sender domain network addresses of email exchanges that are authorized to act as outbound email exchanges for the sender domain.

20. The computer program product of claim 17 wherein the email client is trusted according to the authentication data, and the computer program product further comprises means, recorded on the recording medium, for storing the email client's network address in association with a trust time limit in the list of trusted network addresses.

21. The computer program product of claim 17 further comprising:
means, recorded on the recording medium, for accepting in the email server a connection from an email client requesting delivery of an email message according to a protocol that includes client authentication, wherein the connection includes the network address of the email client requesting delivery of an email message;
means, recorded on the recording medium, for authenticating the email client requesting delivery of an email message;
means, recorded on the recording medium, for delivering the email message to the email client requesting delivery of an email message; and
means, recorded on the recording medium, for storing the network address of the email client requesting delivery of an email message in association with a trust time limit in the list of trusted network addresses.

22. The computer program product of claim 17 wherein the email client is an email exchange that accepts outbound email messages only from trusted senders.

23. The computer program product of claim 17 wherein means, recorded on the recording medium, for receiving a sender domain name further comprises means, recorded on the recording medium, for receiving the sender domain name in an SMTP MAILFROM message.

24. The computer program product of claim 17 further comprising means, recorded on the recording medium, for sending an error message to the email client and means, recorded on the recording medium, for closing the connection if the email client is not trusted according to the email client's network address, the email client is not trusted according to the authentication, and the email client is not trusted according to the sender domain name.
